(19) United States
(12) Patent Application Publication
(10) Pub. No.: US 2007/0076964 A1
(43) Pub. Date: Apr. 5, 2007

(54) Method of and an apparatus for predicting DC coefficient in transform domain

(75) Inventor: Byung-cheol Song, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/514,828

(22) Filed: Sep. 5, 2006

(30) Foreign Application Priority Data
Oct. 1, 2005 (KR) 10-2005-0092659

(51) Int. Cl. G06K 9/36

(52) U.S. Cl. 382/238; 382/236

(57) ABSTRACT

A method of and apparatus for predicting a direct current (DC) coefficient in a transform domain are provided. The method of predicting a DC coefficient of a transform block in video encoding includes calculating a first representative value of pixel values of pixels in the bottom-most row of a neighboring block located above a current block and a second representative value of pixel values of pixels in the right-most column of a neighboring block located to the left of the current block and comparing the first representative value and the second representative value with a predetermined reference value obtained from a block located above and to the left of the current block and selecting a DC coefficient predictor for prediction of the DC coefficient of the current block according to the result of the comparison.

### CROSS REFERENCE TO RELATED PATENT APPLICATION

This application claims priority from Korean Patent Application No. 10-2005-0092659, filed on Oct. 1, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to prediction encoding and decoding of video data, and more particularly, to predicting a direct current (DC) coefficient in a transform domain.

2. Description of the Related Art

Since video contains a large amount of data, compression encoding is essential for storage or transmission of the video data. Intraprediction is a video data compression method in which video data is compressed using similarity between data in a single picture. In international video encoding standards such as Moving Picture Experts Group (MPEG)-1, MPEG-2, and MPEG-4 Part 2 Visual, encoding efficiency is improved using intraprediction with respect to a coefficient transformed in a discrete cosine transform (DCT) domain. In Advanced Video Coding (AVC)/H.264, spatial intraprediction encoding in a spatial domain, instead of a transform domain, is used. For convenience of explanation, intraprediction with respect to a coefficient transformed in a DCT domain will be described. When intraprediction encoding is performed in a transform domain, a transform coefficient of a current block to be encoded is predicted using a transform coefficient of at least one block having correlation with the current block and a difference between an actual transform coefficient of the current block and the predicted transform coefficient is variable-length encoded prior to transmission.

FIG. 1 is a view for explaining intraprediction encoding in a transform domain according to the related art. In FIG. 1, intraprediction encoding adopted in MPEG-4 Part 2 is taken as an example.

Referring to FIG. 1, in the case of MPEG-4 Part 2, a prediction direction for predicting a DC coefficient of a current block X is determined according to differences among DC coefficients of previous blocks A, B, and C in a domain undergoing 8×8 block-based DCT. The DC coefficient indicates a coefficient at (0, 0) of a DCT block. If the previous block A, B, or C is located outside the boundary of a video object plane (VOP) or the boundary of a current video packet or has not been intracoded, its DC coefficient is regarded as 128.

When the quantized DC coefficient of the previous block A is DC_A, the quantized DC coefficient of the previous block B is DC_B, and the quantized DC coefficient of the previous block C is DC_C, a DC coefficient predictor (DC_Predictor) of the current block X is determined as follows:

If |DC_B−DC_A|≦|DC_B−DC_C|, DC_Predictor=DC_C, and

otherwise, DC_Predictor=DC_A.

When the DC coefficient of the current block X is DC_X, it is substituted by a difference (DC_X−DC_Predictor) between the DC coefficient of the current block X and the DC coefficient predictor of the current block X and then encoded through scanning, run length coding, and variable length coding.

In intraprediction encoding in a transform domain according to the related art, the DC coefficient of a current block has correlation with a DC coefficient of a neighboring block of the current block, but accurate prediction of a DC coefficient is not possible due to a distance between the current block and a previous block. Thus, it is necessary to improve the accuracy of prediction of a DC coefficient and compression efficiency.

### SUMMARY OF THE INVENTION

The present invention provides a method of and apparatus for predicting a DC coefficient, in which a DC coefficient of a current block can be more accurately predicted using representative values of pixel values of pixels of neighboring blocks closer to the current block than other neighboring blocks, i.e., the sum of pixel values of pixels of a row located immediately above the current block and the sum of pixel values of pixels of a column located immediately to the left of the current block.

According to one aspect of the present invention, there is provided a method of predicting a DC coefficient of a transform block in video encoding. The method includes calculating a first representative value of pixel values of pixels in the bottom-most row of a neighboring block located above a current block and a second representative value of pixel values of pixels in the right-most column of a neighboring block located to the left of the current block and comparing the first representative value and the second representative value with a predetermined reference value obtained from a block located above and to the left of the current block and selecting a DC coefficient predictor for prediction of the DC coefficient of the current block according to the result of the comparison.

According to another aspect of the present invention, there is provided an apparatus for predicting a DC coefficient of a transform block in video encoding. The apparatus includes a summation unit and a DC coefficient predictor selection unit. The summation unit calculates a first representative value of pixel values of pixels in the bottom-most row of a neighboring block located above a current block and a second representative value of pixel values of pixels in the right-most column of a neighboring block located to the left of the current block. The DC coefficient predictor selection unit compares the first representative value and the second representative value with a predetermined reference value obtained from a block located above and to the left of the current block and selects a DC coefficient predictor for prediction of the DC coefficient of the current block according to the result of the comparison.

According to still another aspect of the present invention, there is provided a method of predicting a DC coefficient of a transform block in video decoding. The method includes performing variable length decoding on a received bitstream to extract a difference between an actual DC coefficient of a current block and a DC coefficient predictor, calculating a first representative value of pixel values of pixels in the bottom-most row of a neighboring block located above the current block and a second representative value of pixel values of pixels in the right-most column of a neighboring block located to the left of the current block, comparing the first representative value and the second representative value with a predetermined reference value obtained from a block located above and to the left of the current block and selecting a DC coefficient predictor for prediction of the DC coefficient of the current block according to the result of the comparison, and adding the extracted difference and the selected DC coefficient predictor to reconstruct the DC coefficient of the current block.

According to yet another aspect of the present invention, there is provided an apparatus for predicting a DC coefficient of a transform block in video decoding. The apparatus includes a summation unit, a DC coefficient predictor selection unit, and an addition unit. The summation unit calculates a first representative value of pixel values of pixels in the bottom-most row of a neighboring block located above a current block and a second representative value of pixel values of pixels in the right-most column of a neighboring block located to the left of the current block. The DC coefficient predictor selection unit compares the first representative value and the second representative value with a predetermined reference value obtained from a block located above and to the left of the current block and selects a DC coefficient predictor for prediction of the DC coefficient of the current block according to the result of the comparison. The addition unit adds a difference between an actual DC coefficient of the current block and a DC coefficient predictor, which is extracted from a variable length decoded bitstream, and the selected DC coefficient predictor.

### BRIEF DESCRIPTION OF THE DRAWINGS

The above and other aspects of the present invention will become more apparent by describing in detail exemplary embodiments thereof with reference to the attached drawings in which:

FIG. 1 is a view for explaining intraprediction encoding in a transform domain according to the related art;

FIG. 2 is a block diagram of a video encoder which uses an apparatus for predicting a DC coefficient according to an exemplary embodiment of the present invention;

FIG. 3 is a detailed block diagram of a prediction unit of FIG. 2 according to an exemplary embodiment of the present invention;

FIG. 4 is a flowchart illustrating a method of predicting a DC coefficient of a transform block in video encoding according to an exemplary embodiment of the present invention;

FIG. 5 is a view for explaining a method of predicting a DC coefficient according to an exemplary embodiment of the present invention;

FIG. 6 is a block diagram of a video decoder which uses an apparatus for predicting a direct current (DC) coefficient according to an exemplary embodiment of the present invention;

FIG. 7 is a detailed block diagram of a prediction unit of FIG. 6 according to an exemplary embodiment of the present invention; and

FIG. 8 is a flowchart illustrating a method of predicting a DC coefficient of a transform block in video decoding according to an exemplary embodiment of the present invention.

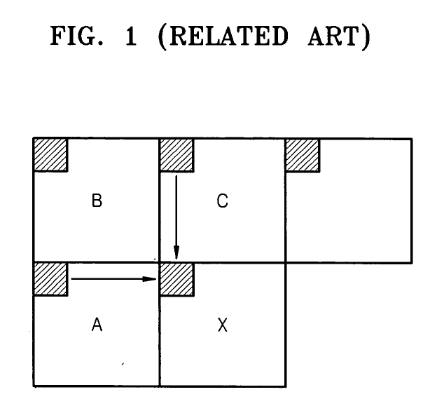

### DETAILED DESCRIPTION OF EXEMPLARY EMBODIMENTS OF THE INVENTION

Hereinafter, exemplary embodiments of the present invention will be described in detail with reference to the accompanying drawings.

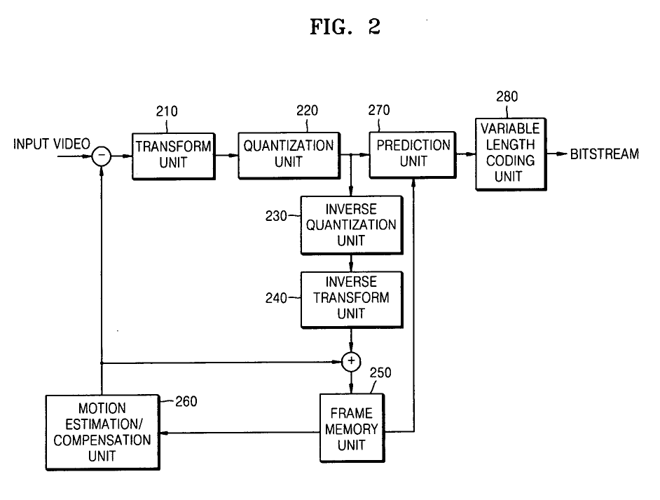

FIG. 2 is a block diagram of a video encoder which uses an apparatus for predicting a DC coefficient according to an exemplary embodiment of the present invention.

Referring to FIG. 2, the video encoder includes a transform unit 210, a quantization unit 220, an inverse quantization unit 230, an inverse transform unit 240, a frame memory unit 250, a motion estimation/compensation unit 260, a prediction unit 270, and a variable length coding unit 280. The apparatus for predicting a DC coefficient according to an exemplary embodiment of the present invention predicts a DC coefficient of a predetermined-size block including quantized transform coefficients that have undergone transform and quantization in a video decoder, and is the prediction unit 270 of FIG. 2. In the following description, for convenience of explanation, the predetermined-size block is assumed to be an 8×8 block including quantized transform coefficients. However, it can be easily construed that the present invention is also applicable to various sized blocks including transform coefficients.

The motion estimation/compensation unit 260 estimates a motion vector per macroblock and the sum of absolute differences corresponding to a block matching error using video data of an input current frame and video data of a previous frame stored in the frame memory unit 250, thereby forming a prediction block.

An error block, i.e., a residual block corresponding to a difference between a current block and the prediction block predicted by the motion estimation/compensation unit 260 or a prediction block predicted by an intraprediction unit (not shown) is input to the transform unit 210.

The transform unit 210 performs discrete cosine transform DCT on the residual block that is input in units of 8×8 pixel blocks to remove spatial correlation and the quantization unit 220 performs quantization on a DCT coefficient obtained by the transform unit 210.

The inverse quantization unit 230 performs inverse quantization on video data quantized by the quantization unit 220. The inverse transform unit 240 performs inverse DCT (IDCT), i.e., inverse transform on video data that is inversely quantized by the inverse quantization unit 230. The frame memory unit 250 stores reconstructed video data that is the sum of the prediction block and the residual block that is reconstructed through inverse transform of the inverse transform unit 240.

The prediction unit 270 according to the present invention selects a DC coefficient predictor DC_Predictor using representative values of pixel values of neighboring pixels that are immediately adjacent to the current block among pixels of previous blocks stored in the frame memory unit 250. The representative value may be one of the average, the median value, the mode, and the temporary average of pixel values. Hereinafter, for convenience of explanation, it is assumed that the representative value is the average of pixel values. The prediction unit 270 also outputs a difference between the actual DC coefficient of a transform block including quantized transform coefficients output from the quantization unit 220 and the selected DC coefficient predictor.

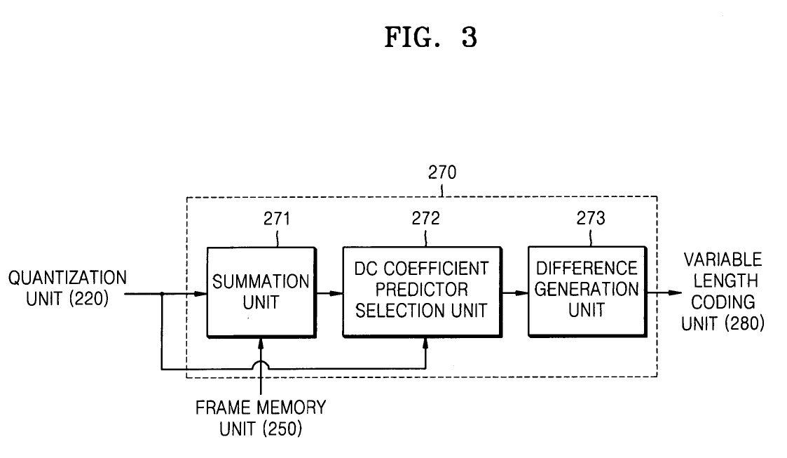

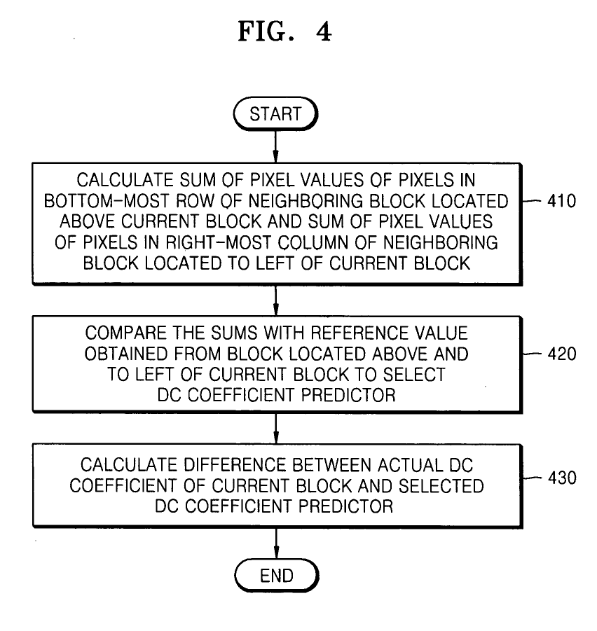

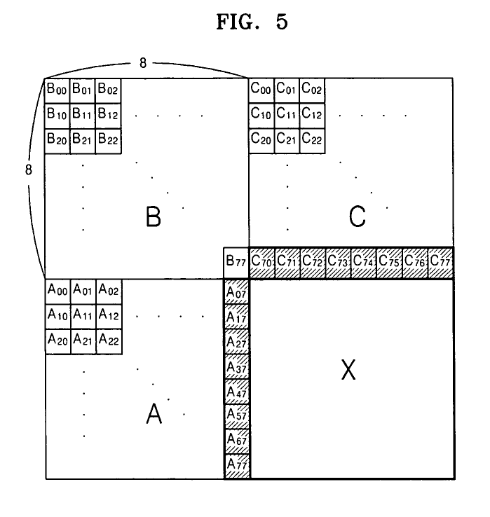

FIG. 3 is a detailed block diagram of the prediction unit 270, FIG. 4 is a flowchart illustrating a method of predicting a DC coefficient of a transform block in video encoding according to an exemplary embodiment of the present invention, and FIG. 5 is a view for explaining a method of predicting a DC coefficient according to an exemplary embodiment of the present invention. An apparatus and method of prediction a DC coefficient of a transform block in video decoding according to the present invention will now be described in detail with reference to FIGS. 3 through 5.

The prediction unit 270 includes a summation unit 271, a DC coefficient predictor selection unit 272, and a difference generation unit 273.

As stated above, the residual block that is a difference between the prediction block generated through interprediction or intraprediction and the current block is transformed by the transform unit 210 and quantized by the quantization unit 220 and a predetermined-size block including quantized transform coefficients is input to the prediction unit 270.

In operation 410, the summation unit 271 extracts neighboring blocks located above and to the left of the current block, which are available for processing the current block, from the frame memory unit 250 according to a raster scan scheme and calculates the sum of pixel values of pixels of the bottom-most row of the neighboring block located above the current block and the sum of pixel values of pixels of the right-most column of the neighboring block located to the left of the current block among pixels of the extracted neighboring blocks.

Referring to FIG. 5, when the current block is indicated by X, the neighboring block located above the current block X is Indicated by C, the neighboring block located to the left of the current block X is indicated by A, and a block located above and to the left of the current block X is indicated by B, the summation unit 271 calculates a sum L_Sum of pixel values of pixels of the right-most column of the neighboring block A, i.e., the sum of pixel values of pixels A₀₇, A₁₇, . . . , A₆₇, and A₇₇. The summation unit 271 also calculates a sum T_Sum of pixel values of pixels of the bottom-most row of the neighboring block C, i.e., the sum of pixel values of pixels C₇₀, C₇₁, . . . , C₇₆, and C₇₇.

In operation 420, the DC coefficient predictor selection unit 272 compares the average of L_Sum and the average of T_Sum calculated by the summation unit 271 with a predetermined reference value R obtained from the block B and selects a DC coefficient predictor for prediction of a DC coefficient of the current block X according to the result of the comparison. The predetermined reference value R may be a pixel value of a pixel B77 located in the right bottom corner of the block B or the average of all or some pixel values of the block B.

More specifically, the DC coefficient predictor selection unit 272 selects a DC coefficient predictor DC_Predictor of the current block X according to the criterion as follows:

$$If \vert R - \frac{T\_Sum}{N} \vert \leq \vert R - \frac{L\_Sum}{M} \vert ,$$

DC_Predictor=L_Pred, and

otherwise, DC_Predictor=T_Pred,

Here, N is the number of pixels in the bottom-most row of the neighboring block C, M is the number of pixels of the right-most column of the neighboring block A, and N and M are 8 in FIG. 5. L_Pred is a left predictor calculated using L_Sum and T_Pred indicates an up predictor calculated using T_Sum. Since the DC coefficient of the current block X is quantized, L_Pred and T_Pred are calculated by multiplying L_Sum and T_Sum by a predetermined scaling coefficient corresponding to a quantization coefficient of the current block X, respectively. In other words, when the quantization block of the current block X is QP and the predetermined scaling coefficient corresponding to QP is Scale(QP), T_Pred=T_Sum×Scale(QP) and L_Pred=L_Sum×Scale(QP).

Next, in operation 430, when the actual DC coefficient of the current block X input from the quantization unit 220 is DC_X, a difference between DC_X and the selected DC coefficient predictor, i.e., DC_X−DC_Predictor is calculated.

The DC coefficient predictor DC_Predictor may be a median value among T_Sum, L_Sum, and the average thereof, i.e., (T_Sum+L_Sum)/2. In other words, DC_Predictor=MEDIAN {T Sum, L_Sum, (T_Sum+L_Sum)/2}.

Referring back to FIG. 2, the variable length coding unit 280 performs variable length coding on the difference between DC_X and DC_Predictor and outputs the result as a bitstream.

In the method of and apparatus for predicting a DC coefficient according to exemplary embodiments of the present invention, the accuracy of prediction of the DC coefficient can be improved by using the sum of pixel values of pixels closer to a current block compared to the related art, thereby improving compression efficiency in video encoding.

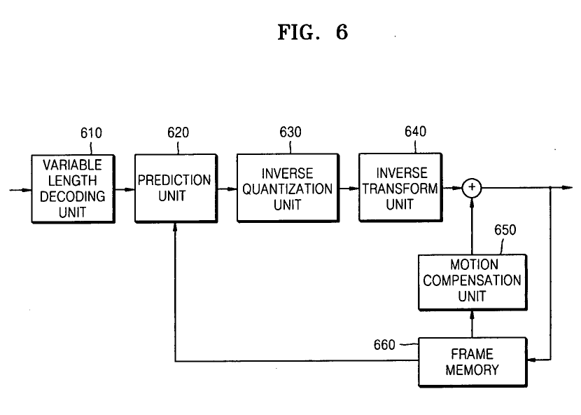

FIG. 6 is a block diagram of a video decoder which uses the apparatus for predicting a DC coefficient according to an exemplary embodiment of the present invention.

Referring to FIG. 6, the video decoder includes a variable-length decoding unit 610, a prediction unit 620, an inverse quantization unit 630, an inverse transform unit 640, a motion compensation unit 650, and a frame memory 660. The apparatus for prediction a DC coefficient of a transform block in video decoding according to an exemplary embodiment of the present invention is the prediction unit 620. The video decoder receives a bitstream encoded by the video encoder as illustrated in FIG. 2, performs variable length decoding on the received bitstream through the variable length decoding unit 610, decodes a DC coefficient of a current transform block through the prediction unit 620, and then performs inverse quantization and inverse transform on the current transform block through the inverse quantization unit 630 and the inverse transform unit 640, thereby reconstructing a residual block. A prediction block predicted through motion compensation of the motion compensation unit 650 or intraprediction of an intraprediction unit (not shown) and the reconstructed residual block are added, thereby obtaining decoded video data.

More specifically, the variable length decoding unit 610 performs variable length decoding on the received bitstream to extract information such as a difference between the actual DC coefficient of the current block and a DC coefficient predictor and a quantization coefficient. The prediction unit 620 selects a DC coefficient predictor using the sum of pixel values of pixels immediately adjacent to the current block among pixels of previous blocks that are decoded and then stored in the frame memory 660 and adds the difference extracted by the variable length decoding unit 610 and the selected DC coefficient predictor, thereby decoding the DC coefficient of the current block.

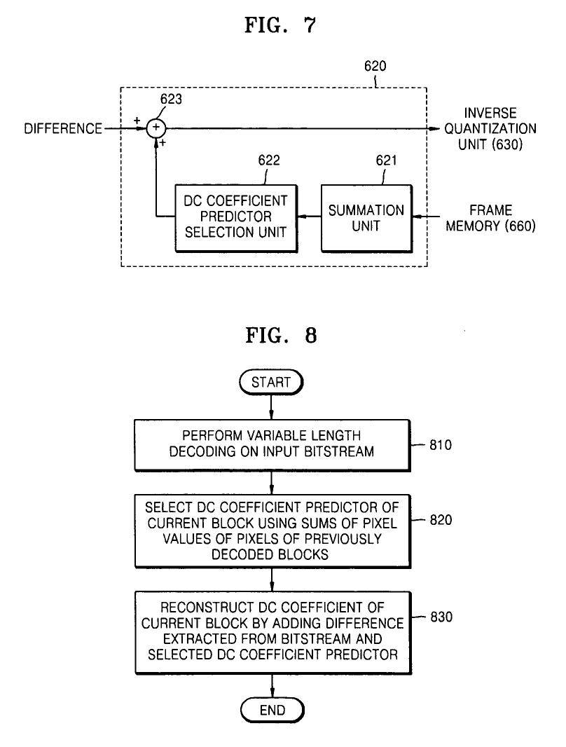

FIG. 7 is a detailed block diagram of the prediction unit 620 of FIG. 6 and FIG. 8 is a flowchart illustrating a method of predicting a DC coefficient of a transform block in video decoding according to an exemplary embodiment of the present invention. Hereinafter, a method of and apparatus for predicting a DC coefficient of a transform block in video decoding according to an exemplary embodiment of the present invention will be described in detail with reference to FIGS. 7 and 8.

Referring to FIG. 7, the prediction unit 620 includes a summation unit 621, a DC coefficient predictor selection unit 622, and an addition unit 623.

In operation 810, the variable length decoding unit 610 receives a bitstream encoded by a video encoder and performs variable length decoding on the received bitstream. The variable length decoding unit 610 extracts information such as a difference between the actual DC coefficient of the current block and a DC coefficient predictor, motion vector information, and a quantization coefficient through variable length decoding.

In operation 820, the summation unit 621 calculates the sum of pixel values of pixels in the bottom-most row of a neighboring block located above the current block and the sum of pixel values of pixels in the right-most column of a neighboring block located to the left of the current block using previous blocks that are decoded and then stored in the frame memory 660. The DC coefficient predictor selection unit 622 compares the average of the sum of pixel values of the pixels in the bottom-most row of the neighboring block and the average of the sum of pixel values of the pixel in the right-most column of the neighboring block with a predetermined reference value obtained from a block located above and to the left of the current block and selects a DC coefficient predictor for prediction of the DC coefficient of the current block according to the result of the comparison. The configuration and operation of the DC coefficient predictor selection unit 622 are the same as those of the DC coefficient predictor selection unit 272 of FIG. 3 and a detailed description thereof will not be provided.

In operation 830, the addition unit 623 adds the extracted difference and the selected DC coefficient predictor to reconstruct the DC coefficient of the current block.

An AC coefficient of a current block can also be predicted using the sum of pixel values of neighboring pixels in the same way as the prediction of the DC coefficient. A transform block including quantized transform coefficients is reconstructed into a residual block after undergoing inverse quantization and inverse transform through the inverse quantization unit 630 and the inverse transform unit 640. The residual block is added to an interpredicted or intrapredicted block, thereby obtaining decoded video data.

As described above, according to the exemplary embodiment of the present invention, the accuracy of prediction of a DC coefficient can be improved by using the sum of pixel values of pixels closer to a current block, thereby improving compression efficiency.

The present invention can also be embodied as a computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves. The computer-readable recording medium can also be distributed over network coupled computer systems so that the computer-readable code is stored and executed in a distributed fashion.

While the present invention has been particularly shown and described with reference to an exemplary embodiment thereof, it will be understood by those of ordinary skill in the art that various changes in form and detail may be made therein without departing from the spirit and scope of the present invention as defined by the following claims.

What is claimed is:

1. A method of predicting a direct current (DC) coefficient of a transform block in video encoding, the method comprising:
calculating a first representative value of pixel values of pixels in a bottom-most row of a neighboring block located above a current block and a second representative value of pixel values of pixels in a right-most column of a neighboring block located to the left of the current block;
comparing the first representative value and the second representative value with a reference value obtained from a block located above and to the left of the current block; and
selecting a DC coefficient predictor for prediction of the DC coefficient of the current block based on a result of the comparing.

2. The method of claim 1, wherein the first representative value or the second representative value comprises one of an average of the pixel values, a median of the pixel values, a mode of the pixel values, and a temporary average of the pixel values.

3. The method of claim 1, wherein the reference value comprises a pixel value of a pixel located in a right bottom comer of the block located above and to the left of the current block.

4. The method of claim 1, wherein the reference value comprises an average of pixel values of all or some pixels of the block located above and to the left of the current block.

5. The method of claim 1, wherein the selecting of the DC coefficient predictor comprises selecting L_Sum as the DC coefficient predictor if
$$\vert R - \frac{T\_Sum}{N} \vert \leq \vert R - \frac{L\_Sum}{M} \vert$$
satisfied and selecting T_Sum as the DC coefficient predictor if
$$\vert R - \frac{T\_Sum}{N} \vert \leq \vert R - \frac{L\_Sum}{M} \vert$$
is not satisfied, wherein R is the reference value, T_Sum is a sum of the pixel values of the pixels in the bottom-most row of the neighboring block, N is a number of pixels in the bottom-most row of the neighboring block, L_Sum is a sum of the pixel values of the pixels in the right-most column of the neighboring block, and M is a number of pixels in the right-most column of the neighboring block.

6. The method of claim 1, further comprising multiplying the selected DC coefficient predictor by a scaling coefficient corresponding to a quantization coefficient of the current block.

7. The method of claim 1, further comprising calculating a difference between an actual DC coefficient of the current block and the selected DC coefficient predictor.

8. The method of claim 1, wherein the selecting of the DC coefficient predictor comprises selecting a medium value among a sum of the pixel values of the pixels in the bottom-most row of the neighboring block, a sum of the pixel values of the pixels in the right-most column of the neighboring block, and an average of the sum of the pixel values of the pixels in the bottom-most row of the neighboring block and the sum of the pixel values of the pixels in the right-most column of the neighboring block as the DC coefficient predictor for the current block.

9. An apparatus which predicts a direct current (DC) coefficient of a transform block in video encoding, the apparatus comprising:
a summation unit which calculates a first representative value of pixel values of pixels in a bottom-most row of a neighboring block located above a current block and a second representative value of pixel values of pixels in a right-most column of a neighboring block located to the left of the current block; and
a DC coefficient predictor selection unit which compares the first representative value and the second representative value with a reference value obtained from a block located above and to the left of the current block and selects a DC coefficient predictor for prediction of the DC coefficient of the current block based on a result of the comparison.

10. The apparatus of claim 9, wherein the first representative value or the second representative value is one of an average of the pixel values, a median of the pixel values, a mode of the pixel values, and a temporary average of the pixel values.

11. The apparatus of claim 9, wherein the reference value is a pixel value of a pixel located in a right bottom comer of the block located above and to the left of the current block.

12. The apparatus of claim 9, wherein the reference value is an average of pixel values of all or some pixels of the block located above and to the left of the current block.

13. The apparatus of claim 9, wherein the DC coefficient predictor selection unit selects L_Sum as the DC coefficient predictor if
$$\vert R - \frac{T\_Sum}{N} \vert \leq \vert R - \frac{L\_Sum}{M} \vert$$
is satisfied and selects T_Sum as the DC coefficient predictor if
$$\vert R - \frac{T\_Sum}{N} \vert \leq \vert R - \frac{L\_Sum}{M} \vert$$
is not satisfied, wherein R is the reference value, T_Sum is a sum of the pixel values of the pixels in the bottom-most row of the neighboring block, N is a number of pixels in the bottom-most row of the neighboring block, L_Sum is a sum of pixel values of the pixels in the right-most column of the neighboring block, and M is a number of pixels in the right-most column of the neighboring block.

14. The apparatus of claim 9, wherein the DC coefficient predictor selection unit generates a final DC coefficient predictor by multiplying the selected DC coefficient predictor by a scaling coefficient corresponding to a quantization coefficient of the current block.

15. The apparatus of claim 9, further comprising a difference calculation unit calculating a difference between an actual DC coefficient of the current block and the selected DC coefficient predictor.

16. The apparatus of claim 9, wherein the DC coefficient predictor selection unit selects a medium value among a sum of the pixel values of the pixels in the bottom-most row of the neighboring block, a sum of the pixel values of the pixels in the right-most column of the neighboring block, and an average of the sum of the pixel values of the pixels in the bottom-most row of the neighboring block and the sum of the pixel values of the pixels in the right-most column of the neighboring block as the DC coefficient predictor for the current block.

17. A method of predicting a direct current (DC) coefficient of a transform block in video decoding, the method comprising:
performing variable length decoding on a received bitstream to extract a difference between an actual DC coefficient of a current block and a DC coefficient predictor;
calculating a first representative value of pixel values of pixels in the bottom-most row of a neighboring block located above the current block and a second representative value of pixel values of pixels in a right-most column of a neighboring block located to the left of the current block;
comparing the first representative value and the second representative value with a reference value obtained from a block located above and to the left of the current block;
selecting a DC coefficient predictor for prediction of the DC coefficient of the current block based on a result of the comparing; and
adding the extracted difference and the selected DC coefficient predictor to reconstruct the DC coefficient of the current block.

18. The method of claim 17, wherein the first representative value or the second representative value is one of an average of the pixel values, a median of the pixel values, a mode of the pixel values, and a temporary average of the pixel values.

19. The method of claim 17, wherein the reference value is a pixel value of a pixel located in the right bottom comer of the block located above and left of the current block.

20. The method of claim 17, wherein the reference value is an average of pixel values of all or some pixels of the block located above and to the left of the current block.

21. The method of claim 17, wherein the selection of the DC coefficient predictor comprises selecting L_Sum as the DC coefficient predictor if
$$\vert R - \frac{T\_Sum}{N} \vert \leq \vert R - \frac{L\_Sum}{M} \vert$$
is satisfied and selecting T_Sum as the DC coefficient predictor if
$$\vert R - \frac{T\_Sum}{N} \vert \leq \vert R - \frac{L\_Sum}{M} \vert$$
is not satisfied, wherein R is the reference value, T_Sum is a sum of the pixel values of the pixels in the bottom-most row of the neighboring block, N is a number of pixels in the bottom-most row of the neighboring block, L_Sum is a sum of the pixel values of the pixels in the right-most column of the neighboring block, and M is a number of pixels in the right-most column of the neighboring block.

22. The method of claim 17, further comprising multiplying the selected DC coefficient predictor by a scaling coefficient corresponding to a quantization coefficient of the current block.

23. An apparatus for predicting a direct current (DC) coefficient of a transform block in video decoding, the apparatus comprising:
a summation unit which calculates a first representative value of pixel values of pixels in a bottom-most row of a neighboring block located above a current block and a second representative value of pixel values of pixels in a right-most column of a neighboring block located to the left of the current block;
a DC coefficient predictor selection unit which compares the first representative value and the second representative value with a reference value obtained from a block located above and left of the current block and selects a DC coefficient predictor for prediction of the DC coefficient of the current block based on a result of the comparison; and
an addition unit which adds a difference between an actual DC coefficient of the current block and a DC coefficient predictor, which is extracted from a variable length decoded bitstream, and the selected DC coefficient predictor.

24. The apparatus of claim 23, wherein the first representative value or the second representative value is one of an average, median, mode, and temporary average of the pixels values.

25. The apparatus of claim 23, wherein the reference value is a pixel value of a pixel located in the right bottom comer of the block located above and to the left of the current block.

26. The apparatus of claim 23, wherein the reference value is an average of pixels values of all or some pixels of the block located above and to the left of the current block.

27. The apparatus of claim 23, wherein the DC coefficient predictor selection unit selects L_Sum as the DC coefficient predictor if
$$\vert R - \frac{T\_Sum}{N} \vert \leq \vert R - \frac{L\_Sum}{M} \vert$$
is satisfied and selects T_Sum as the DC coefficient predictor if
$$\vert R - \frac{T\_Sum}{N} \vert \leq \vert R - \frac{L\_Sum}{M} \vert$$
is not satisfied, wherein R is the reference value, T_Sum is a sum of the pixel values of the pixels in the bottom-most row of the neighboring block, N is a number of pixels in the bottom-most row of the neighboring block, L_Sum is a sum of the pixel values of the pixels in the right-most column of the neighboring block, and M is a number of pixels in the right-most column of the neighboring block.

28. The apparatus of claim 23, wherein the DC coefficient predictor selection unit multiplies the selected DC coefficient predictor by a scaling coefficient corresponding to a quantization coefficient of the current block.

29. A computer-readable recording medium having stored thereon a computer program, wherein the program performs a method, the method comprising:
calculating a first representative value of pixel values of pixels in a bottom-most row of a neighboring block located above a current block and a second representative value of pixel values of pixels in a right-most column of a neighboring block located to the left of the current block;
comparing the first representative value and the second representative value with a reference value obtained from a block located above and to the left of the current block; and
selecting a DC coefficient predictor for prediction of the DC coefficient of the current block based on a result of the comparing.

30. A computer-readable recording medium having stored thereon a computer program, wherein the program performs a method, the method comprising:
performing variable length decoding on a received bitstream to extract a difference between an actual DC coefficient of a current block and a DC coefficient predictor;
calculating a first representative value of pixel values of pixels in the bottom-most row of a neighboring block located above the current block and a second representative value of pixel values of pixels in a right-most column of a neighboring block located to the left of the current block;
comparing the first representative value and the second representative value with a reference value obtained from a block located above and to the left of the current block;
selecting a DC coefficient predictor for prediction of the DC coefficient of the current block based on a result of the comparing; and
adding the extracted difference and the selected DC coefficient predictor to reconstruct the DC coefficient of the current block.
